(19) United States
(12) Patent Application Publication
(10) Pub. No.: US 2010/0035680 A1
(43) Pub. Date: Feb. 11, 2010

(54) Gambling Apparatus and Method

(76) Inventor: László Barta, Gyomaendrod (HU)

Correspondence Address: BEEM PATENT LAW FIRM, 53 W. JACKSON BLVD., SUITE 1352, CHICAGO, IL, 60604-3787, US

(21) Appl. No.: 12/446,957

(22) PCT Filed: Oct. 29, 2007
(86) PCT No.: PCT/HU2007/000105

§ 371 Date: Apr. 23, 2009

(30) Foreign Application Priority Data
Oct. 30, 2006 (HU) P 06 00817

(51) Int. Cl. A63F 9/24

(52) U.S. Cl. 463/25; 463/42; 463/43

(57) ABSTRACT

The invention is a gambling apparatus, having a betting storage unit (22), a unit for storing a local gaming amount, and a gambling unit carrying out local gambling on the basis of a random factor. The apparatus comprises a computer unit (47) for keeping in touch with a specified set of further gambling apparatuses (40), on the basis of the apparatuses (40) a regional prize fund is determined, and the computer unit (47) enables carrying out gambling on the regional prize fund in accordance with a bet stored in the betting storage unit (22). The invention also relates to a method for operating the above system.

### TECHNICAL FIELD

The invention relates to a gambling (i.e. betting-drawing) apparatus and method suitable for local gambling, online gambling and regional gambling.

### BACKGROUND ART

There are many prior art gambling apparatuses and methods, which are appropriate for local gambling, i.e. gambling at the location of the apparatus. The known apparatuses have a betting storage unit, in which a betting combination entered by a user in accordance with the given apparatus is stored. The known apparatuses also have a unit for storing a gaming amount, i.e. storing the amount devoted by the user for the bet(s) or the corresponding electronic information. Consequently, the gaming amount is such an allocation from which the stake, i.e. the price of participating in each gambling can be paid, and the prize is preferably added to the gaming amount associated with the user. The prize is paid from the so-called prize fund, which is a financial amount made available by the service provider. The amount of this fund is subject for example to the stakes paid (lost) by the users. Once the stake and the gambling combination are entered, the known apparatuses use a method known per se to conduct local gambling on the basis of a random factor, and the eventual prize resulting from the gambling is paid to the user on the spot.

Such a known gambling apparatus is described for example in U.S. Pat. No. 5,702,302, and an approach related to such an apparatus is described in WO 95/21425. The disadvantage of these known gambling apparatuses is that they do not allow the user to join any centrally conducted gambling method via the apparatus. Such centrally conducted gambling methods, in which the bets can be forwarded through data transmission channels to a centre, will hereinafter be called as online or regional gambling.

In WO 01/60472 a system is described which allows central conducting of a gambling.

However, there is no such gambling apparatus and method, which enables the conducting of gambling on the basis of a so-called regional prize fund by communicating with a specified set of other gambling apparatuses.

### DESCRIPTION OF THE INVENTION

It is an object of the invention to create such a gambling apparatus and method, which are suitable for conducting not only local gambling and online gambling, but also regional gambling. It is also an object to design an apparatus which can be handled simply, meets user requirements the best, and can be switched flexibly from and to local, online and regional gambling functions.

The apparatus according to the invention is defined by the features of claim 1, and the method according to the invention is defined by the features of claim 11. Preferred embodiments are defined in the dependent claims.

### BRIEF DESCRIPTION OF DRAWINGS

The invention will hereinafter be described on the basis of preferred embodiments depicted by drawings, where

FIG. 1 is a block diagram of an apparatus according to the invention,

FIG. 2 is a schematic view of a data transmission system linking the inventive apparatuses to an online or regional gambling system,

FIG. 3 is a schematic front view of a gambling apparatus used by way of example,

FIG. 4 is a schematic structural view of a betting surface of the apparatus shown in FIG. 3,

FIG. 5 is a schematic view of a gambling unit in the apparatus shown in FIG. 3, and

FIG. 6 is a schematic view of a coverage card which can be used as a means of payment in the method according to the invention.

### MODES FOR CARRYING OUT THE INVENTION

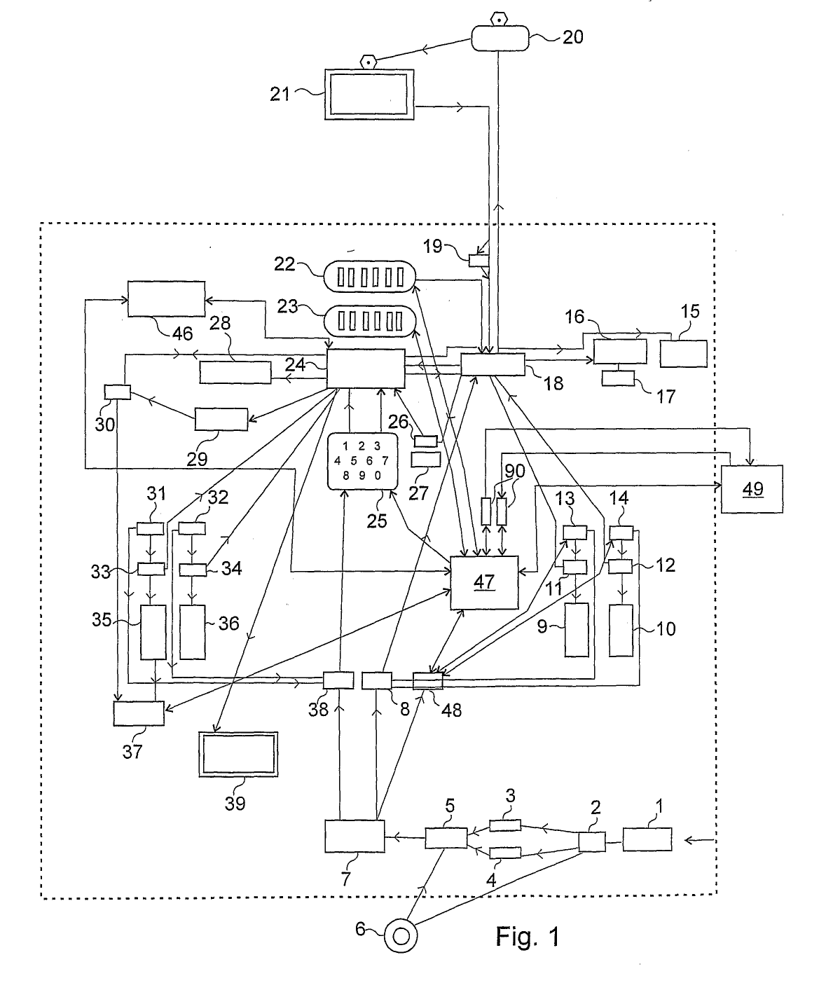

The gambling apparatus 40 used as an example and shown in FIG. 1 comprises a power supply 1 for providing power to the apparatus 40, a safety release unit 2 which is actuated in the case of an internal technical defect or unauthorised intervention from the outside, a reductor (power supply) 3 designed for supplying power to components used in online gambling, a reductor 4 designed for supplying power to units applied in local gambling, and a switch 5 controllable by an operator/maintenance person. The latter switch 5 is designed with an internal enclosed installation, and it has a signal receiver unit designed for operation with a remote control unit 6. The apparatus 40 also comprises a stabiliser 7 known per se for ensuring trouble-free power supply to and operation of the apparatus.

According to the invention, the apparatus 40 preferably comprises controls that enable the selection of the following: local gambling mode, online gambling mode and regional gambling (so-called mini terminal) mode. One of these controls is a pushbutton 8 to trigger online gambling, which pushbutton 8 is actuated in the apparatus preferably after the payment of the gaming amount. For the actuating of the pushbutton 8, money can be inserted particularly in the form of coins or banknotes, and payment may also be made by a coverage card to be described later. The coins may be charged into the apparatus 40 through a coin slot 13, and from here the coins are taken to a container 9 via a counter 11 known per se. The counter 11 preferably comprises a signal transmitter for activating the pushbutton 8, and thereby to enable the starting of gambling. Banknotes can be loaded into the apparatus 40 via an automatic retracting unit 14. From here, banknotes are transferred to a container 10 via a reader 12 known per se. Preferably, the reader 12 also comprises a signal transmitter described above.

By pressing the pushbutton 8, a control unit 18 is activated. This unit is linked to a printer unit 16 located in a secure protected housing. The printing unit 16 serves for printing a receipt which verifies on-line gambling. The printed receipt can be removed via a dispensing unit 17 connected to the printer unit 16. Furthermore, the control unit 18 is linked to a verification dispensing unit 15, which serves for issuing verifications about higher local prizes.

Via a relay station 20, the control unit 18 transmits data to and from a main data centre 21, which carries out database handling tasks, conducts online gambling and handles the related data transfer activities. To verify online betting, a relay 19 (signal detector/storing unit) is preferably located between the control unit 18 and the data centre 21. This unit is advantageous from the aspect of secure recording the online bets.

The apparatus 40 furthermore comprises a betting storage unit 22. This unit can be used for storing the gambling combination(s), for example numeral pairs according to the preferred embodiment to be described later. Preferably, the betting storage unit 22 has an external digital display for the user. The local gambling is implemented by a rotary disk unit 23, which is controlled by a central unit 24. The rotary disk unit 23 is operated on the basis of a random factor known per se. The rotary disk unit 23 may also be implemented in an electronic design. The task of the central unit 24 also comprises switching from and to the local, online and regional modes, the controlling of enabling and disabling activities in each mode of operation and the performing of display and data transfer functions.

Users may enter their bets preferably via a touch screen unit 25, which allows the selection of single-digit numbers in the numeral pairs used as an example. This function may also be performed in the given case in a pushbutton design.

In the preferred embodiment of the invention depicted as an example, it is possible for the user to transfer the local gaming amount available as a result of the local gambling to the online or regional gaming amount. This can be preferably implemented by means of a pushbutton 26. In this way it becomes possible that by means of the gambling apparatus used so far only for local gambling, the local prize is invested into a broader range gambling which has the potential of a higher prize. This function is convenient for the users, because they do not have to bother about the physical removal of their prize, and by means of the receipt received about the transfer they can simply verify applying for participation in online gambling.

The apparatus 40 furthermore comprises a display 28 which serves for displaying the hits in local gambling functions.

In the embodiment of the invention used as an example, a jackpot unit 29 is also arranged. It preferably comprises a pushbutton to be operated by the user for indicating participation in the local jackpot gambling, which is preferably joint gambling implemented by some apparatuses 40 linked to each other, and these apparatuses 40 may be, for example, located in the same casino or in various similar locations.

If the user desires to take his prize from local gambling, he may get his money by means of a pushbutton 30, which is linked to a dispensing unit 37, and this is in turn connected to a container 35 holding coins. In the way depicted in FIG. 1, the apparatus 40 comprises a slot 31 which allows cash payment in local gambling, a counter 33 for inserted coins, a retracting unit 32 for inserting banknotes, an associated reader 34 and a container 36 for storing the banknotes. In the given case, the apparatus 40 does not comprise a separate payment unit for local bets, but cash payment may be made by means of the units designed for online payment.

The local gambling function can be triggered by actuating a pushbutton 38, which is preferably activated also via signal transmitters in the units designed for cash payment.

Preferably, the apparatus 40 also comprises a black box 39 which is a secure data store, and performs the recording of the process of local gambling, online gambling and regional gambling, in addition to saving the associated data securely on an ongoing basis.

Preferably, the apparatus 40 also comprises a relay type betting unit 46 which enables telephone gambling. This betting unit 46 is linked to the central unit 24. A telephone number is assigned to each apparatus 40 for enabling telephone gambling.

It is an important feature of the apparatus 40 according to the invention that it comprises a computer unit 47 or a mini terminal designed for keeping in touch with a defined number of further gambling apparatuses 40. The apparatuses 40 identify a regional prize fund, which is preferably determined on the basis of the cash turnover of the given apparatuses 40.

According to the invention, ‘regional gambling’ is primarily understood as a gambling implemented by means of apparatuses 40 in a given area (settlement, district, town, county, region), but the word ‘regional’ covers all sets of apparatuses comprising apparatuses 40 grouped on the basis of one or more criterion (e.g. Internet link).

On the basis of the bet stored in the betting storage unit 22, the computer unit 47 enables the execution of gambling on the basis of the regional prize fund. Gambling is conducted similarly to online gambling. The computer unit 47 is preferably a PC, which has a program designed for database handling tasks.

The computer unit 47 is preferably linked via a central computer unit 98 to a defined set of further gambling apparatuses 40. The computer unit 47 is preferably connected via telecommunication units 90 located in the apparatus 40 to the central computer unit 49, preferably in a cordless telecommunication mode. As an example, the telecommunication units 90 can be microwave signal transmitters and signal receivers, by which the apparatuses 40 located in the covered area are involved in the method of regional gambling. The power of signal transmitters and signal receivers can be adjusted in accordance with the contracts relating to the operation of the apparatuses 40, and in this way the distribution of market presence to limited areas, as well as regional licensing and supervising can be ensured simply. The control of the telecommunication units 90 is preferably carried out by the computer unit 47.

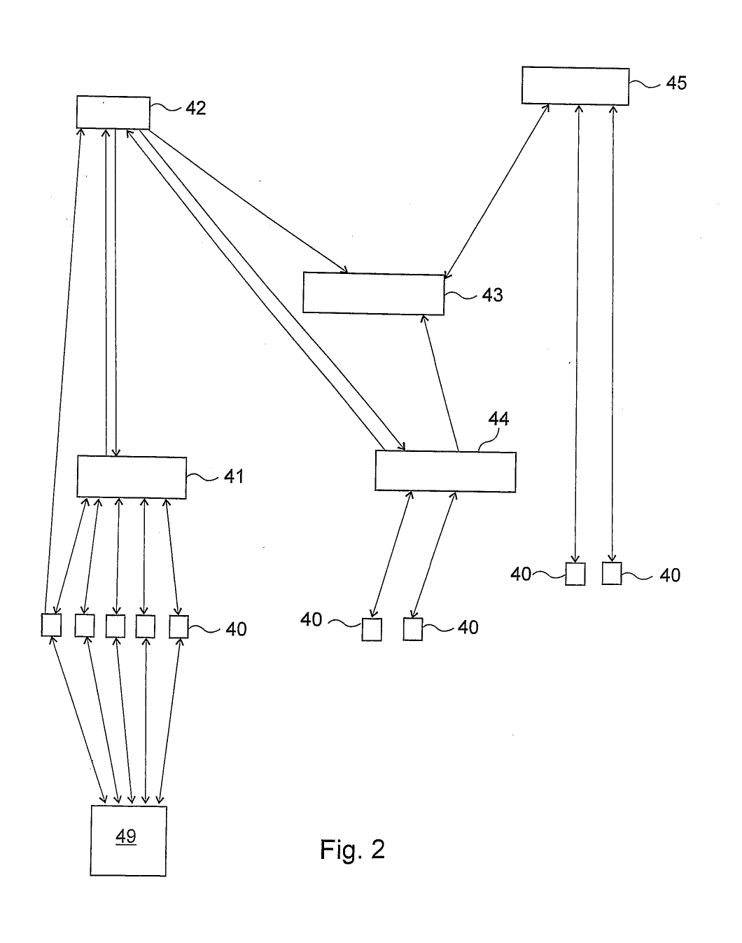

In the structural view shown in FIG. 2, there are apparatuses 40 located in various positions and connected to one another via data transmission channels. A sub-centre 41 shown in the figure links some, in the depicted case five apparatuses 40. The sub-centre 41, for example, can be set up in a casino or a different gaming room, and as an example it can be designed for local jackpot gambling. The sub-centre 41 is preferably linked to a central terminal 43 via a satellite 42 to allow data transmission, and said central terminal 43 can be set up for example as a nation-wide centre, by comprising the data centre 21. Through this terminal, for example, nation-wide jackpot gambling events can be organised. According to the invention, each apparatus 40 is also suitable for enabling participation in online gambling. This is depicted in the figure by the arrow pointing from the first apparatus 40 to the satellite 42. Furthermore, via the satellite 42 betting-shops 44 are linked to the nation-wide network. The betting-shops 44 may also be linked to the apparatuses 40 and they can be located, for example, in restaurants, clubs and bars. Preferably, the central terminal 43 is linked to a satellite 45 which enables international communication, and through the satellite 45 gambling can be extended to several countries or even on a global level. In order to ensure system flexibility, furthermore, international gambling operations can be conducted on such apparatuses 40, which are linked directly or via a relay station to the satellite 45.

The group consisting of apparatuses 40 shown on the left hand side of the figure is in a communication relationship with the central computer unit 49 in order to enable regional gambling according to the invention.

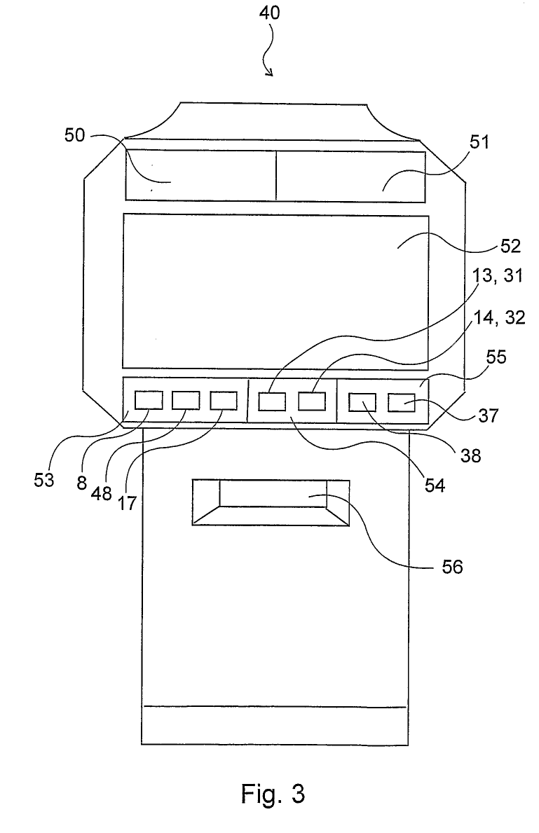

The front view shown in FIG. 3 depicts an example design of the apparatus 40. Preferably, charts 50, 51 are fitted on the apparatus to provide information about the process of gambling as well as on the winning opportunities and chances. The most important control surface of the apparatus 40 is a betting surface 52, which will be detailed later. The apparatus also comprises an online/regional control surface 53, within which the pushbutton 8, the pushbutton 48 and the dispensing unit 17 are located. The slots 13 and 31 as well as the retracting units 14 and 32 are preferably arranged on the cash payment unit 54. A local control surface 55 serves for locating the pushbutton 38 and the dispensing unit 37. Furthermore, the apparatus 40 may comprise a coin dispensing unit 56 which serves e.g. for returning the coins rejected by the apparatus 40.

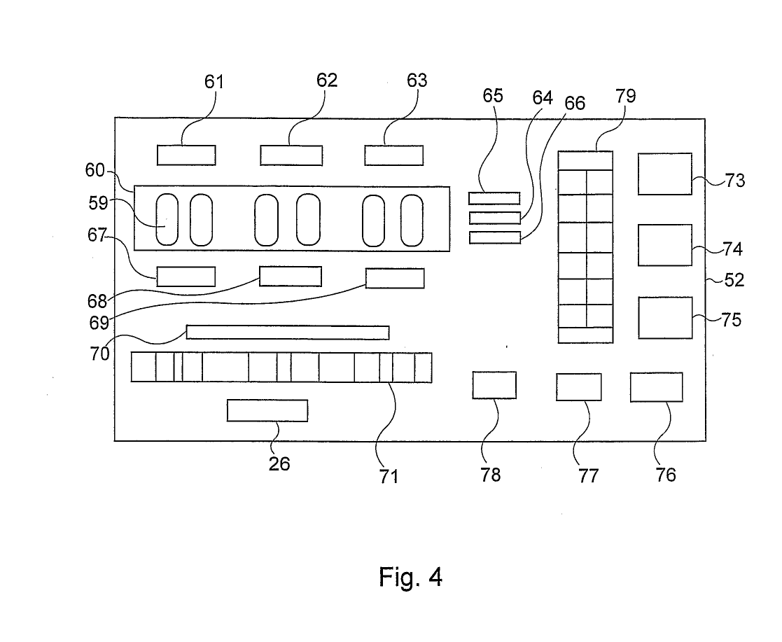

The main part of the betting surface 52 shown in FIG. 4 is the gambling unit 60, which comprises numeral disks 59 to be described later. These disks are arranged in pairs in the preferred embodiment shown; above these pairs the sequence number of the pairs are shown by labels 61, 62 and 63, and below them the stakes are shown by labels 67, 68 and 69. Next to the gambling unit 60, a label 64 showing the line of the main hit being in the centre line of the gambling unit 60 and labels 65, 66 showing the lines of side-hits arranged above and below are located.

The number series selected by the user are displayed in a number series display 71. Above the display, for the user's information, a label 70 is located to inform the user on things to know about the series of betting numbers.

Preferably, the betting surface 52 also comprises a betting input unit 79, which is preferably the touch screen unit 25. On the betting surface 52, a display 73 serves for displaying the gaming amount. A display 74 serves for displaying the prize, a display 75 serves for displaying the gaming amount made available for online gambling and displays 76, 77 and 78 serve for displaying the stakes.

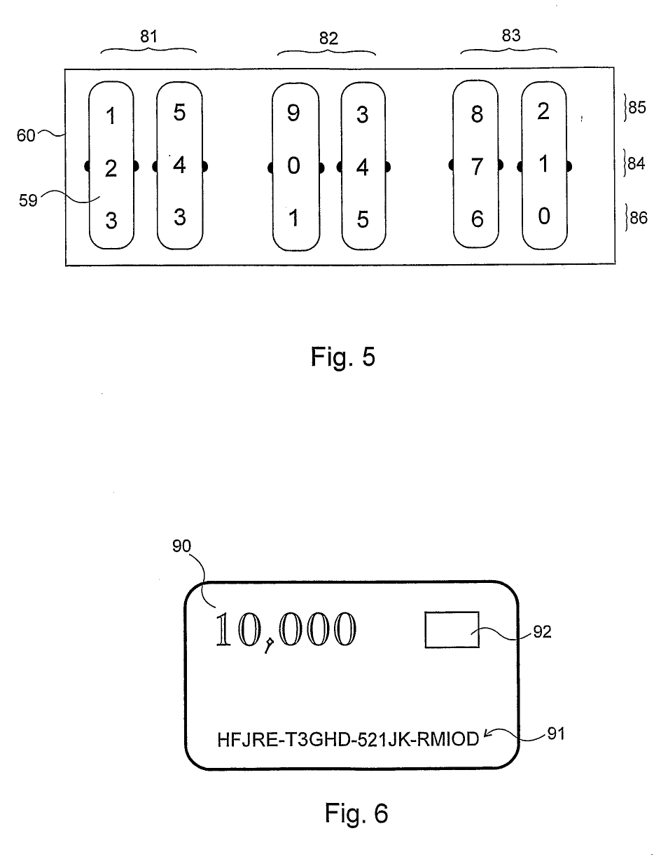

Consequently, the gambling unit 60 shown in FIG. 5 comprises pairs consisting of the numeral disks 59 as described above. The numeral disks 59 are controlled in a way that they can be rotated independently of each other. Preferably, the numeral disks 59 are rotated on a random basis in a varying direction and with a varying rate at the time when the gambling is started. Preferably, the stopping of the numeral disks 59 also takes place on a random basis. In a way shown in the figure, single-digit numbers are located from 0 to 9 preferably in a rising sequence on the outer surface of the numeral disks 59. The disks 59 are preferably located in the apparatus 40 in a way that simultaneously one below the other three single-digit numbers are shown at each disk. The preferred embodiment used as an example comprises three pairs of numeral disks.

When making a bet, the user chooses numeral pairs consisting of single digit numbers. The user may freely decide whether to bet on one, two or three numeral pairs. The gaming amount to be entered is also adjusted to the number of specified numeral pairs. The user may only commence gambling preferably after selecting one of the three stakes, and then paying the amount due. Without the payment of gaming amount, the apparatus 40 does not perform a gambling function.

After paying the gaming amount, the user may decide whether to participate in local gambling, online gambling or regional gambling. This can be done as described above by actuating the pushbuttons 8, 38 and 48, respectively.

The next step is choosing a number of digits which correspond to the selected stake. The user chooses two numbers when selecting a stake corresponding to one numeral pair, four numbers in the case of selecting a stake corresponding to two numeral pairs, and six numbers when choosing a stake corresponding to three numeral pairs. This can be done by means of the gambling input unit 79 in the way mentioned above. The selected numeral pairs are stored by means of a pushbutton in the betting storage unit 22 of the apparatus 40, and then displayed. This series of numbers may not be changed subsequently by the user.

Next, the user triggers the gambling process preferably by pressing a pushbutton. When selecting a stake corresponding to one numeral pair, only the first two numeral disks 59 are rotating, and they result in the first numeral pair 81. When choosing a stake corresponding to two numeral pairs, the first four disks are rotating, which results in the first and second numeral pairs 81, 82. When choosing a stake corresponding to three numeral pairs, all the six numeral disks 59 are rotating, resulting in the first, second and third numeral pairs 81, 82, 83.

As an example, when selecting a stake corresponding to one numeral pair, a prize is only due if a hit is made on the main hit line 84. This means that in order to get a prize, the numeral pair specified by the user (gambler, staker) must appear in the main hit line 84 of the first numeral disk pair 59.

Also when selecting a stake corresponding to two numeral pairs, as an example, a prize is only obtained on a hit in the main hit line 84. According to the invention, the prize is highest if the user makes a hit of the sequence of numeral pairs, too. The prize is lower, if the numeral pairs are the same as the bet, but their sequence is not and it is even lower if only one of the numeral pairs is hit at its place, and even lower if only one numeral pair is hit and not at its place. The hits mentioned in this last sentence are called sub-hits.

When selecting a stake corresponding to three numeral pairs, i.e. when choosing the highest betting prize, the prize is highest according to the invention if the user also hits the sequence of numeral pairs. A lower prize is obtained on sub-hits, and it is even lower when the hits and sub-hits are on the upper side-hit line 85 and on the lower side-hit line 86.

In the case of a local gambling, the current prize fund is preferably determined by the financial revenues of the given apparatus 40. In the case of online betting, the expected prize is preferably magnitudes higher even in the case of main, side and sub-hits, and the amount is determined centrally. In the case of regional gambling, the prize fund (regional prize fund) is preferably an amount adjusted to the cash turnover of the apparatuses 40 located in a specified area.

When choosing the local gambling function, the apparatus 40 pays the prizes on the spot in the case of smaller amounts. Above a pre-specified limit, the apparatus 40 does not issue cash, but prints a voucher about the prize to the user/gambler.

As described above, users may put their prizes won by local gambling into an online or regional gaming amount and they also have the opportunity to apply for online or regional gambling with a series of numbers selected for local gambling. In the case of online and regional gambling, the apparatus 40 does not preferably give a local payout, but only prints a receipt that verifies participation in the game.

Regional gambling can be triggered by pressing the pushbutton 48. Then the apparatus 40 preferably shows on display 73 to the gambler the amount of regional prize fund, the so called bonus. At the same time, the digit surface of the touch screen unit 25 is actuated, and there the gambler can set up his/her own combination. The adjusted combination is registered and displayed by the apparatus 40. After this, by means of the disk system described above, the gambling is started, which can be stopped by the gambler, and which automatically stops after a specified period, as an example after 10 sec. Finally, the apparatus 40 displays to the gambler the amount won from the regional prize fund, and preferably prints a receipt which verifies the prize.

It is apparent to a person skilled in the art that the apparatus according to the invention can be implemented on a purely software basis, in which case the units representing the parts of the apparatus are designed as software units, i.e. as software modules. It is also conceivable that only some of the units representing parts of the apparatus are designed as software. Such embodiments are to be understood of course also as falling into the scope of protection.

The apparatus implemented on a purely software basis may have a web page type of appearance as an example, with a log-in surface and a registration module. If gambling is made on the basis of an Internet user surface, it preferably comprises means for entering the gambling combination, means for displaying the combination resulting from the gambling and means for showing the prize. The apparatus may be implemented for example in the form of an Internet or online game. In the registration, the handling of the account and the data registration can be implemented preferably by an MYSQL database manager and furthermore by a PHP, HTML coupling. The software codes can be preferably created in an encrypted version.

To provide efficient protection, the algorithm and the coding key are burnt in separate data storage means, for example DVDs, and only the program emulating the inventive apparatus may have access thereto. If any of the data storage means is removed, the program is halted. The program does not start without the data storage means and the information on the various data storage means may not be used separately.

When entering the game, first an appropriate identification (by submitting e-mail address, password) is carried out. After identification, the user may start the game, when the program accesses the key on the first data storage means, and then by using this key the algorithm on the second data storage means is deciphered. After running the algorithm, that is after gambling, the program displays the result which is preferably done by the stopping of rotary disks. Now the program evaluates the prize class and the eventual prize. If a prize has been won, the program credits the prize on the user's account and the game can be re-started.

Of course, the apparatus 40 according to the invention may be designed in a way deviating from the description above within the scope of protection defined by the claims. It is possible, for example, to use other than three numeral disk 59 pairs, and to use a gambling unit 60 different from that described. The gaming amount may be inputted in the apparatus 40 not only in the form of cash, but also, for example, by means of a bank or credit card, or even more preferably, by means of the coverage card to be described below.

Consequently, in the method and apparatus according to the invention, keeping in touch with a specified set of betting centres (e.g. other gambling apparatuses or web access points associated with such devices), at least partly on the basis of the information coming from the betting centres, a regional prize fund is defined, and on the basis of the gambling stored in the betting storage unit, the gambling is carried out on a regional prize fund basis. The regional prize fund can be generated from the cash turnover of betting centres involved in the regional system, e.g. as a specified percentage thereof, but of course a different method for calculating the prize fund is possible.

It is an advantage of the solution according to the invention that by means of an appropriate fixing of the regional gaming amount, the gamblers can be encouraged to make larger stakes and thereby the game can be made more exciting.

The relatively high amounts of regional and online prize funds may of course necessitate betting stakes of higher amounts. In a supervised way—preferably in the framework of public draw—telephone betting may also be enabled.

According to an especially preferred embodiment of the invention, it is possible to pay in the gaming amount by means of a coverage card depicted in FIG. 6. The amount 90 available on the coverage card is centrally booked. When purchasing the coverage card, the card is registered with the name and address, and eventually other personal details (e.g. mother's name, date of birth) of the buyer. Any eventual prize is posted to the specified address, therefore, in the case of the coverage cards according to the invention, it is not necessary to make a complex registration similar to bank cards and credit cards.

A code number 91 consisting preferably of a series of characters is shown on the coverage card, and furthermore a PIN code is assigned to the card. Payment with the coverage card is subject to the checking of code number, PIN code and/or one or more personal data. Preferably, the buyer's initials are also printed on the card in an appropriate field 92.

The coverage card based system according to the invention is more beneficial also from the aspect of game security and data protection, and therefore it is expected to replace the bank or credit card payment systems.

The method according to the invention may also be run in a lottery ticket system, when the bet storage unit is represented by a field of three numeral pairs pre-printed on the lottery ticket, and the entering of the gambling combination corresponds to selecting a lottery ticket (and thereby the three numeral pairs). Gambling on the basis of a random factor is carried out at the time of printing the lottery ticket, as a result of which a combination consisting of a further three numeral pairs covered with a scratch-off surface is generated. Information relating to the available prize fund, which can be a reference to an identification point (e.g. an Internet address) of a regional prize fund is preferably printed in this case on the backside of the lottery ticket.

According to the actual prize fund, the lottery tickets can have various colour codes so that the buyers can identify the lottery tickets easier.

The functions of the inventive apparatus can be operated separately and it is not absolutely necessary to make sure that all the three gambling options are in operation simultaneously. The apparatuses operated in this way are also be considered to fall within the scope of protection of the following claims.

1. A gambling apparatus, having a betting storage unit, a unit for storing a local gaming amount, and a gambling unit carrying out local gambling on the basis of a random factor, characterised by comprising a computer unit (47) for keeping in touch with a specified set of further gambling apparatuses (40), on the basis of the apparatuses (40) a regional prize fund is determined, and the computer unit (47) enables carrying out gambling on the regional prize fund in accordance with a bet stored in the betting storage unit (22).

2. The apparatus according to claim 1, characterised in that the computer unit (47) is linked to a specified set of other gambling apparatuses (40) via a central computer unit (49).

3. The apparatus according to claim 2, characterised in that the computer unit (47) is linked with the central computer unit (49) via telecommunication units (90) arranged in the apparatus (40), preferably in cordless telecommunication.

4. The apparatus according to claim 1, characterised by comprising a central control unit (18) which enables participation in gambling on an online prize fund via a data transmission channel, wherein the bet stored in the betting storage unit (22) is transmitted for online gambling.

5. The apparatus according to claim 4, characterised by comprising a central control unit (18) enabling to use the local gaming amount as a regional gaming amount or as an online gaming amount.

6. The apparatus according to claim 5, characterised by having controls, preferably pushbuttons (8, 38, 48) which enable the selection of local gambling mode, online gambling mode and regional gambling mode.

7. The apparatus according to claim 1, characterised by having a betting input unit (79) suitable for selecting numeral pairs (81, 82, 83) consisting of single digit numbers as a bet, and the a gambling unit performing the local gambling comprises pairs consisting of numeral disks (59) which can be rotated independently.

8. The apparatus according to claim 7, characterised in that the number of numeral pairs (81, 82, 83) is three, and the number of rotary numeral disks (5) is six.

9. The apparatus according to claim 8, characterised in that the numeral disks (59) are arranged side by side in the apparatus (40) so that they display three numbers one below the other out of the single digit numbers arranged on their outer surfaces, and the prize combinations are defined by the numeral pairs appearing in three lines.

10. The apparatus according to any of the claims 1 to 9, characterised in that at least some of its units are implemented in software.

11. A method for conducting gambling, comprising the steps of entering a betting combination into a betting storage unit, carrying out gambling on the basis of a random factor, and on the basis of a combination generated as a result of gambling, in dependence of an available prize fund, the prize is determined, characterised by keeping in touch with a specified set of further betting points, determining a regional prize fund at least partly on the basis of information received from the betting points, and on the basis of the betting stored in the betting storage unit, gambling is carried out on the regional prize fund.

12. The method according to claim 11, characterised in that numeral pairs consisting of single digit numbers are selected as the bet, and gambling is carried out by means of pairs consisting of numeral disks that can be rotated independently.

13. The method according to claim 12, characterised in that the number of numeral pairs is three and the number of rotary numeral disks is six.

14. The method according to claim 11, characterised by enabling participation in gambling on an online prize fund via a data transmission channel, wherein the bet stored in the betting storage unit is transferred for the online gambling.

15. The method according to claim 14, characterised by enabling the use of the local gaming amount as a regional gaming amount or as an online gaming amount.

16. The method according to any of claims 11 to 15, characterised by conducting gambling by means of an Internet user surface, which comprises means for entering a betting combination, means for displaying the combination generated as a result of the gambling, and means for showing the prize.

17. The method according to any of claims 11 to 15, characterised by also enabling telephone betting in a supervised way, preferably in the framework of a public draw.

18. The method according to any of claims 11 to 15, characterised by enabling the payment of the gaming amount by means of a coverage card, wherein the amount available on the coverage card is booked centrally.

19. The method according to claim 18, characterised in that the coverage card is registered at the time of purchase with the customer's name, address and eventually other personal data, and that any eventual prize is posted to the registered address.

20. The method according to claim 18, characterised by indicating a code number on the coverage card, and furthermore assigning a PIN code to the card, and enabling payment with the coverage card subject to checking the code number, the PIN code and/or one or more personal data.

21. The method according to claim 11, characterised by implementing the method by means of lottery tickets.
